(19) United States
(12) Patent Application Publication
(10) Pub. No.: US 2024/0011543 A1
(43) Pub. Date: Jan. 11, 2024

(54) GEARBOX ASSEMBLY WITH ASYMMETRIC RACK-AND-PINION SYSTEM

(71) Applicant: WedgeRock LLC, Limerick, ME (US)

(72) Inventor: Jesse Morin, Buxton, ME (US)

(73) Assignee: WedgeRock LLC, Limerick, ME (US)

(21) Appl. No.: 17/862,108

(22) Filed: Jul. 11, 2022

(51) Int. Cl. F16H 19/04

(52) U.S. Cl. CPC F16H 19/04

(57) ABSTRACT

A load control device including an asymmetrical rack-and-pinion system coupled to a gear set and to a load such that movement of the asymmetrical rack-and-pinion system causes movement of the load, and a biasing element coupled to the asymmetrical rack-and-pinion system. The rack is asymmetrical in that it is configured with a variable linear profile and the pinion is asymmetrical in that its pitch line varies as it rotates. The biasing element may be a coil spring. The asymmetrical rack-and-pinion system may be a single device or a paired set of a first asymmetrical rack-and-pinion device and a second asymmetrical rack-and-pinion device.

### BACKGROUND OF THE INVENTION

### 1. Field of the Invention.

The present invention relates to an apparatus configured to convert source force to output force. More particularly, the present invention is a drive actuator with an asymmetrical rack-and-pinion apparatus causing more direct and effective output force conversion to the application. The asymmetric apparatus may be an eccentric rack-and-pinion gear apparatus but not limited thereto.

### 2. Description of the Prior Art.

Industrial load control devices provide the means by which large loads are moved in a regulated manner. One example of a load control device is a flow control device such as a valve designed to regulate the movement of fluid through a pathway. Other large loads also require controlled movement. Ideally, these load control devices include a fail-safe mechanism to limit or prevent adverse impact of otherwise uncontrolled movement of the large load. In the example of a flow control valve, the fail-safe mechanism functions to open or close the valve as needed to maintain or prevent flow through the pathway.

U.S. Pat. No. 9,890,865 (“the '865 patent’) describes a flow control system for controlling the operation of a valve. The system of the '865 patent includes as primary components a load, such as a flow controller described as a flow control valve in particular, a manual or automated actuator that rotates a shaft, a transfer gear set designed to transfer rotational movement of the shaft, a rack-and-pinion system that actuates the flow controller, and a biasing element that enables the performance of a fail-safe function in conjunction with the rack-and-pinion system. The biasing element is described as a spring in the '965 patent.

In operation, the pinion of the rack-and-pinion system performs the function of rotating to transfer the rotational movement of the transfer gear set into rotational movement of the load or at least something connected to the load, which may be a valve. The pinion includes teeth that engage with teeth of the rack such that rotational movement of the pinion translates into linear movement of the rack. In the system of the '965 patent, the rack is coupled to the biasing element. The linear movement of the rack causes movement of the biasing element. When the biasing element is a spring that is coupled to the rack, the rack compresses the spring. When the load control system includes the fail-safe mechanism, that fail-safe mechanism may be configured to decouple the drive train. The biasing element then performs the function of causing linear movement of the rack, which in turn causes rotational movement of the pinion to either cause up or down, in or out, or clockwise or counterclockwise movement of the load. If the load is a valve, that movement may be clockwise or counterclockwise to block or enable movement of a fluid through the pathway.

It is important, then, that the rack-and-pinion system and the biasing element perform efficiently and thoroughly to enable effective fail-safe performance. An aspect of the impact of the combination of the rack-and-pinion system and a spring such as a coil spring as the biasing element, is the operation of the spring. For a large load, which may be a flow control valve but not limited thereto, when a coil spring is compressed, the potential energy of the spring increases until reaching full compression. Therefore, the force of the rack required to compress the spring increases through full compression and spring output force decreases as the spring extends.

In practical applications in which mechanical force is applied by the rack, if asymmetrical potential force can be converted more closely to the required application force profile, the overall applied efficiency of the mechanism is improved. Establishing an application force profile more closely aligned with the load movement profile has substantial and material commercial advantages. One advantage being the ability to use smaller springs to achieve the required application load profile. The spring as biasing element does not have a uniform force profile transition from fully compressed to fully extended and yet existing rack-and-pinion systems interact with the spring along a uniform force profile. What is needed is a rack-and- pinion system that applies force to the biasing element asymmetrically throughout the complete transition from fully compressed to fully extended.

### SUMMARY OF THE INVENTION

The present invention is a rack-and-pinion system that applies force to the biasing element asymmetrically throughout the complete transition from fully compressed to fully extended. The invention provides substantial and material commercial advantages in mechanical torque and thrust applications including, but not limited to load movement control. A biasing element such as a coil spring reaches maximum output force at full compression and typically about half the maximum force when extended to its preload position. In an alternative configuration, the coil spring function similarly at full extension rather than full compression. Typical applications do not follow diminishing force across the range of cycle operation as noted. The present invention provides a more effective means of converting mechanically generated force over a range. That means an asymmetrical rack-and-pinion system is beneficial mechanically and commercially.

The rack-and-pinion system of the present invention operates substantially as is known for existing rack-and-pinion systems, including that which is described in the '965 patent. However, the rack and the pinion are modified in a way that results in variable pinion torque with a given rack thrust. In particular, the rack is asymmetrical in that it is configured with a variable linear profile. In addition, the pinion is asymmetrical in that its pitch line varies as it rotates. In particular, the pinion is asymmetrical in that its pitch line varies as it rotates, and the rack profile is conjugate to the pinion profile. The combination of the rack with variable linear profile engaged with the variably rotatable pinion ensures that conversion of mechanically generated force on the biasing element over the range of movement of the biasing element is not linear but is instead aligned with the asymmetry of the force provide by that biasing element through its movement range. The invention thereby more effectively converts source force to output force.

In an example of the operation of the asymmetrical rack-and-pinion system of the present invention, torque is produced by a biasing element such as a coil spring that acts on the rack to cause variably linear movement of the rack having the variably linear profile. The torque output is calculated by multiplying force times radius measured from the center of rotation of the pinion. The resulting design allows the mechanism to be variable and that can be modified to the application force profile. This is achieved by the invention as a gearbox assembly including a rack comprising rack teeth arranged along a curved profile along a length of the rack, and a pinion comprising pinion teeth engaged with the rack teeth to form a rack-and-pinion interface having an asymmetrical profile that may be a curved profile. The pinion is configured to rotate around an axis. The resultant torque curve of the gearbox assembly is based on the curved profile of the rack and pinion interface. It is noted that the gearbox assembly may be formed of a plurality of such asymmetrical rack-and-pinion assemblies. It is to be noted that the invention may be implemented as a pair of opposing rack-and-pinion devices in a first rack-and-pinion system, or in a single device configuration. The present invention is a drive actuator with an asymmetrical rack-and-pinion apparatus causing more direct and effective output force conversion to the application. The asymmetric apparatus may be an eccentric rack-and-pinion gear apparatus but not limited thereto.

### BRIEF DESCRIPTION OF THE DRAWINGS

FIG. 1 is a perspective view of a load control movement device of the present invention with dual asymmetric rack-and-pinion system.

FIG. 2 is a cross-sectional top view of the load control movement device of FIG. 1.

FIG. 3 is a perspective view of the load control movement device of FIG. 1 with a first one of the rack-and-pinion devices of the dual asymmetric rack-and-pinion system and associated coil spring exposed.

FIG. 4 is a perspective view of the load control movement device of FIG. 1 with a second one of the rack-and-pinion devices of the dual asymmetric rack-and-pinion system and associated coil spring exposed.

FIG. 5 is a perspective view of a load control movement device of the present invention with a single asymmetric rack-and-pinion system.

FIG. 6 is a cross-sectional top view of the load control movement device of FIG. 5.

FIG. 7 is a perspective view of the load control movement device of FIG. 5 with the rack-and-pinion system and associated coil spring exposed.

### DETAILED DESCRIPTION OF THE INVENTION

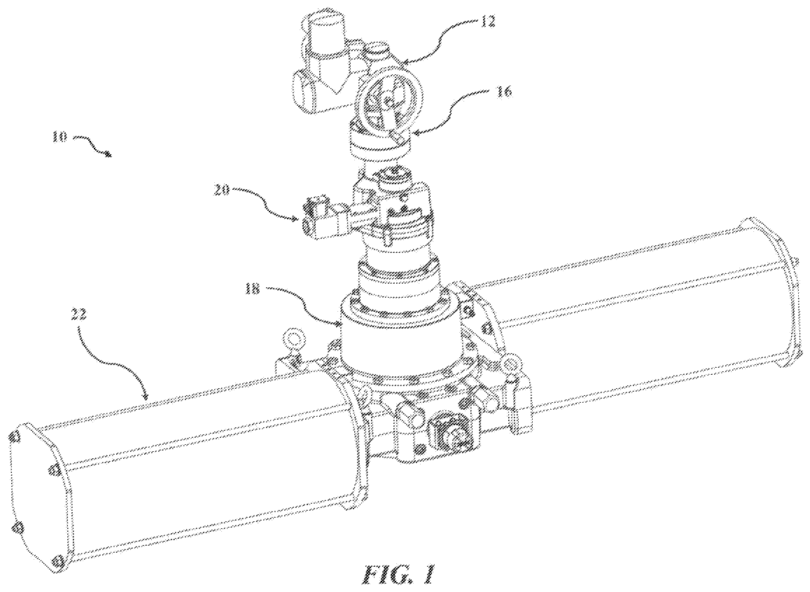

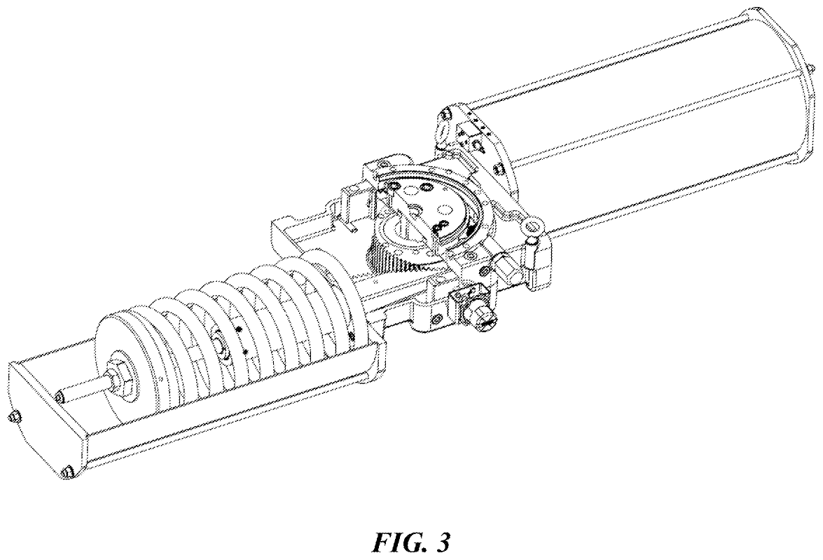

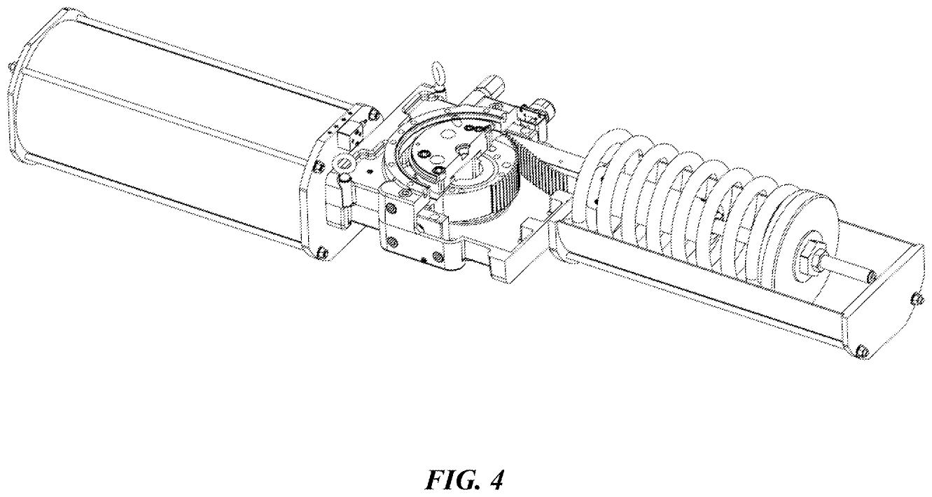

A first load control movement device 10 of the present invention is shown in FIGS. 1-4. The load control movement device 10 includes an actuator 12, a shaft 14, a first gear set 16, a second gear set 18, a fail-safe mechanism 20, and a biasing element 22. The second gear set 18 is represented as a stack of three gear sets. It is to be understood that the second gear set 18 may comprise one or more gear sets and, optionally, there may be no second gear set 18. The device 10 is configured to enable controlled movement of a load, such as a valve. It is to be understood that the load may be something other than a valve.

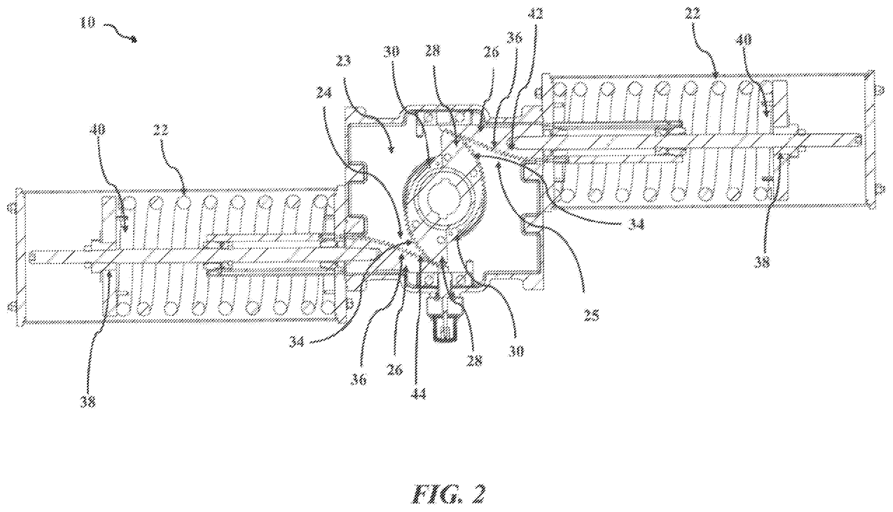

As shown in FIG. 2, the second gear set 18 of the device 10 of FIGS. 1-4 of the present invention is a gearbox assembly comprising a dual rack-and-pinion system 23 including a first rack-and-pinion device 24 and a second rack-and-pinion device 25 that work in tandem. Each of the first rack-and-pinion device 24 and the second rack-and-pinion device 25 includes a rack-and-pinion gear including a rack 26 and a pinion 28. The pinion 28 is coupled directly or indirectly to one or more of the gears of the first gear set 16 at first pinion end 30, and to the load at second pinion end 32. Movement by the actuator 12 of the shaft 14 causes movement of the gears of the first gear set 16, which causes movement of the pinion 28 and, thereby, movement of the load. The pinion 28 includes pinion teeth 34 that are engaged with rack teeth 36 of the rack 26. When the pinion 28 rotates, the pinion teeth 34 engaged with the rack teeth 36 translate that rotational pinion movement into linear movement of the rack 26. An end 38 of the rack 26 is coupled to the biasing element 22, such as end 40 of the coil spring that is the biasing element 22 depicted in FIGS. 2-4.

In operation, when there is an interest in moving the load, such as by opening or closing the valve, the actuator 12 is actuated so as to cause rotation of the shaft 14, which is coupled to the actuator 12. The actuator 12 may be a motor or a handwheel but not limited thereto. Gears of the first gear set 16 are coupled to the shaft 14 and movement of the shaft 14 causes movement of the gears of the first gear set 16. The first gear set 16 may be a planetary gear set but is not limited thereto. The first gear set 16 is coupled to the fail-safe mechanism 20. Movement of the first gear set causes movement of the fail-safe mechanism 20. The fail-safe mechanism is coupled to the second gear set 18 and, as a result, movement of the gears of the first gear set 16 causes movement of gears of the second gear set 18 through the fail-safe mechanism. The second gear set 18 is coupled to the pinion 28 which is coupled to the load. Movement of the pinion 28 causes movement of the load as desired.

The fail-safe mechanism 20 holds the energized biasing element 22 in place until a fail condition is met. When a fail condition is met, the fail-safe mechanism releases the drive train and allows the energized biasing element 22 to move the drive train and output to its fail-safe position. The fail-safe mechanism 20 may be the hold-and-release mechanism disclosed in published PCT patent application serial no. PCT/US2019/014636, the entire content of which is incorporated herein by reference. The fail-safe mechanism described in that PCT application prevents backdrive of the entire assembly and also decouples the second gear set 18 from the shaft 14.

The fail-safe mechanism 20 works in conjunction with the biasing element 22 to perform a fail open or fail close condition as needed. The biasing element 22 may be a coil spring but is not limited thereto. The biasing element 22 is coupled through the rack 26 and pinion 28 to the gears of the second gear set 18. When the fail-safe mechanism 20 activates it decouples the shaft 14 from the second gear set 18. But for the fail-safe mechanism 20, the biasing element 22 would drive movement of the gear train from the rack 26 to the input shaft 14. Instead, when the fail-safe mechanism 20 effectively decouples the second gear set 18 from the shaft 14, the biasing element 22 drives the pinion 28 to which it is coupled, such as to cause movement of the load in a desired direction, whether up, down, in, out, or open or closed as may be desired.

When the first gear set 16 is engaged with the shaft 14 and the pinion 28 rotates in a first direction, the rack 26 moves in a linear first direction and forces the coil spring 22 to a compressed state. When the rack and pinion system 23 is disengaged from the shaft 14, such as by the fail-safe mechanism 20, the potential energy of the compressed coil spring 22 is released so that the coil spring 22 returns to an extended state. That extension of the coil spring 22 causes movement of the rack 26 of each of the first and second devices 24 and 25 in a linear second direction opposite to that of the first direction. The rack 26 so moved and engaged with the pinion 28 causes counter-rotation of the pinion 28, thereby either maintaining the load in a desired position or reversing the position of the load.

With reference to FIGS. 2-4, each of the rack 26 and the pinion 28 has an asymmetrical construct. Specifically, the rack 26 includes an asymmetrical rack section an example of which is a rack arcuate section 42 including the rack teeth 36, and the pinion 28 includes an asymmetrical pinion section an example of which is an extended pinion arcuate section 44 including the pinion teeth 34. The asymmetrical rack 26 is configured with a variable linear profile. In addition, the asymmetrical pinion 28 has a pitch line that varies as it rotates. The combination of the rack 26 with variable linear profile engaged with the variably rotatable pinion 28 ensures that conversion of mechanically generated force on the biasing element 22 over the range of movement of the biasing element 22 is not linear but is instead aligned with the asymmetry of the force provide by that biasing element 22 through its movement range. The device with the second gear set 18 including the asymmetrical rack 26 and asymmetrical pinion 28 thereby more effectively converts source force to output force.

In operation, torque is produced by the biasing element 22 that acts on the rack 26 to cause variably linear movement of the rack 26 having the variably linear profile. The torque output is calculated by multiplying force times radius measured from a center of rotation 46 of the pinion 28. The resulting design allows the rack-and-pinion system 23 to function variably and, in particular, modified to be applicable to a particular force profile of interest. The combination of the rack with variable linear profile engaged with the variably rotatable pinion ensures that conversion of mechanically generated force on the biasing element over the range of movement of the biasing element is not linear but is instead aligned with the asymmetry of the force provide by that biasing element through its movement range. The invention thereby more effectively converts source force to output force. That is, a smaller apparatus made possible by the present invention accomplishes control of loads previously requiring larger apparatuses to achieve.

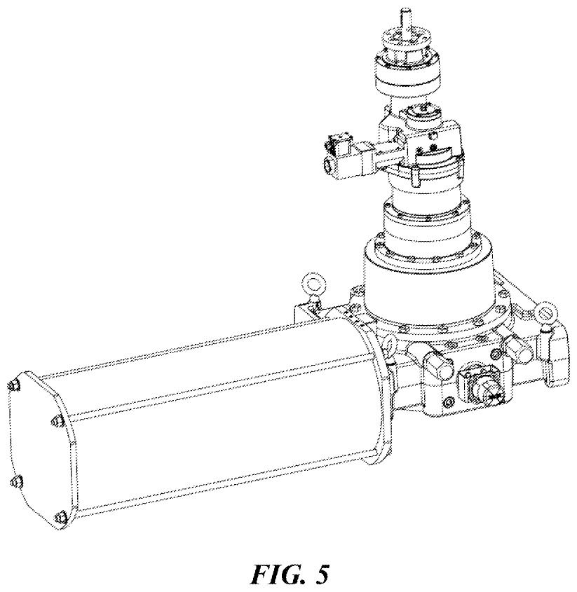

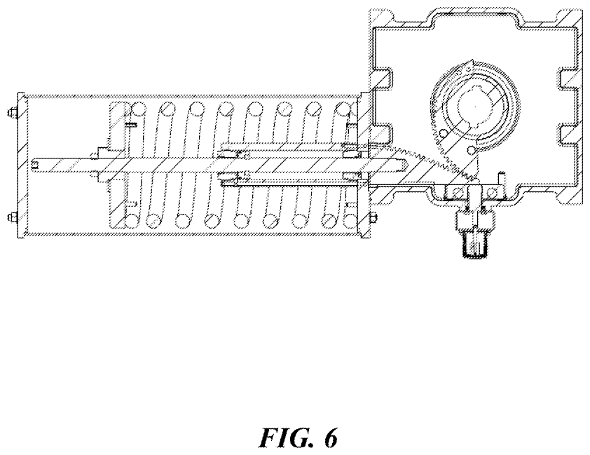

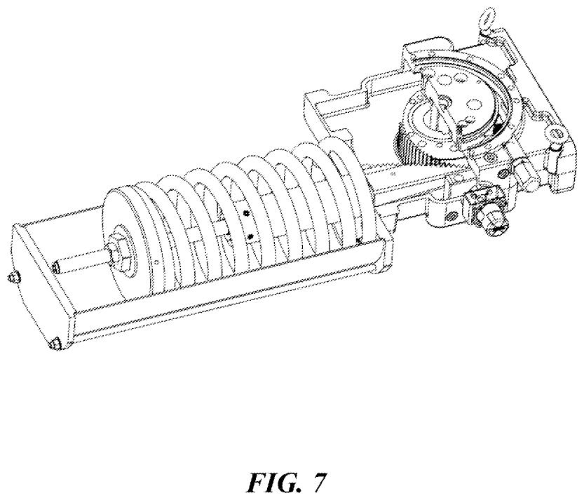

With reference to FIGS. 5-7, a second embodiment of the present invention includes a second load control movement device 100 including a single rack-and-pinion system 102 comprising the same components of either the first rack-and-pinion device 24 or the second rack-and-pinion device 25 of FIGS. 1-4. The single rack-and-pinion system 102 includes the rack-and-pinion gear including a rack 26 and a pinion 28. The pinion 28 is coupled to one or more of the gears of the first gear set 16 at first pinion end 30, and to the load at second pinion end 32. Movement by the actuator 12 of the shaft 14 causes movement of the gears of the first gear set 16, which causes movement of the pinion 28 and, thereby, movement of a load. The pinion 28 includes the pinion teeth 34 that are engaged with the rack teeth 36 of the rack 26. When the pinion 28 rotates, the pinion teeth 34 engaged with the rack teeth 36 translate that rotational pinion movement into linear movement of the rack 26. The end 38 of the rack 26 is coupled to the biasing element 22, such as the end 40 of the coil spring that is the biasing element 22 depicted in FIGS. 6 and 7.

When the first gear set 16 is engaged with the shaft 14 and the pinion 28 rotates in a first direction, the rack 26 moves in a linear first direction and forces the coil spring 22 to a compressed state. When the rack and pinion system 102 is disengaged from the shaft 14, such as by the fail-safe mechanism 20, the potential energy of the compressed coil spring 22 is released so that the coil spring 22 returns to an extended state. That extension of the coil spring 22 causes movement of the rack 26 in a linear second direction opposite to that of the first direction. The rack 26 so moved and engaged with the pinion 28 causes counter-rotation of the pinion 28, thereby either maintaining the load in a desired position or reversing the position of the load.

With reference to FIGS. 6 and 7, each of the rack 26 and the pinion 28 has an asymmetrical construct. Specifically, the rack 26 includes an asymmetrical rack section an example of which is the rack arcuate section 42 including the rack teeth 36, and the pinion 28 includes an asymmetrical pinion section an example of which is the extended pinion arcuate section 44 including the pinion teeth 34. The asymmetrical rack 26 is configured with a variable linear profile. In addition, the asymmetrical pinion 28 has a pitch line that varies as it rotates. The combination of the rack 26 with variable linear profile engaged with the variably rotatable pinion 28 ensures that conversion of mechanically generated force on the biasing element 22 over the range of movement of the biasing element 22 is not linear but is instead aligned with the asymmetry of the force provide by that biasing element 22 through its movement range. The device with the second gear set 18 including the asymmetrical rack 26 and asymmetrical pinion 28 thereby more effectively converts source force to output force.

In operation, torque is produced by the biasing element 22 that acts on the rack 26 to cause variably linear movement of the rack 26 having the variably linear profile. The torque output is calculated by multiplying force times radius measured from a center of rotation 46 of the pinion 28. The resulting design allows the rack-and-pinion system 102 to function variably and, in particular, modified to be applicable to a particular force profile of interest.

1. A load control device comprising:
a shaft;
a gear set coupled to the shaft;
a fail-safe mechanism coupled to the gear set;
an asymmetrical rack-and-pinion system including a rack with variable linear profile and a variably rotatable pinion, wherein the asymmetrical rack-and-pinion system is coupled to the gear set and to the load such that movement of the asymmetrical rack-and-pinion system causes movement of the load; and
a biasing element coupled to the asymmetrical rack-and-pinion system wherein the biasing element provides an asymmetrical force and has a range of movement,
wherein the asymmetrical rack-and-pinion system coupled to the biasing element converts mechanically generated force on the biasing element over the range of movement of the biasing element that is in alignment with the asymmetrical force provided by the biasing element through its range of movement.

2. The load control device of claim 1, wherein the biasing element is a coil spring.

3. The load control device of claim 1, wherein the asymmetrical rack-and-pinion system includes an asymmetrical rack and an asymmetrical pinion.

4. The load control device of claim 3, wherein the pinion is asymmetrical in that its pitch line varies as it rotates and the rack profile is conjugate to the pinion profile.

5. The load control device of claim 4, wherein the rack and the pinion are eccentric.

6. The load control device of claim 1, wherein the asymmetrical rack-and-pinion system includes a single rack-and-pinion system.

7. The load control device of claim 1, wherein the asymmetrical rack-and-pinion system includes a first rack-and-pinion device paired with a second rack-and-pinion device.
